(19) United States
(12) Patent Application Publication
(10) Pub. No.: US 2021/0303002 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP); Hidekazu OHNISHI, Saitama (JP)

(73) Assignee: HONDA MOTOR CO., LTD., Tokyo (JP)

(21) Appl. No.: 17/209,789

(22) Filed: Mar. 23, 2021

(30) Foreign Application Priority Data
Mar. 30, 2020 (JP) 2020-061636

(51) Int. Cl. G05D 1/02

(52) U.S. Cl. CPC G05D 1/0295; G05D 2201/0213; G05D 1/0223; G05D 1/0293

(57) ABSTRACT

A parking lot management device which manages a parking lot for accommodating a vehicle, includes a specification unit which specifies a movement direction or target position of the vehicle moving in the parking lot, and a processor which groups a vehicle group consisting of a plurality of moving bodies moving in the same movement direction or a plurality of moving bodies moving toward the same target position when there are a plurality of moving bodies moving in the parking lot. The processor sets a leading vehicle which should be a head from the grouped vehicle group and moves the moving group with the set leading vehicle at the head while maintaining a constant interval.

### CROSS-REFERENCE TO RELATED APPLICATIONS

The present application claims the benefit of priority of Japanese Patent Application No. 2020-061636, filed on Mar. 30, 2020, the content of which is incorporated herein by reference.

### TECHNICAL FIELD

The present invention relates to an accommodation area management device which manages an accommodation area capable of accommodating a moving body.

### BACKGROUND

JP-A-2007-219738 discloses a technique in which a self-driving control device which controls automatic traveling of a vehicle automatically travels the vehicle to a predetermined parking frame and parks the vehicle based on parking information from a parking information management device.

### SUMMARY

However, in the related art, a technique for controlling a plurality of moving bodies in an accommodation area which can accommodate a moving body such as a vehicle has not been sufficiently studied, and in particular, there is room for improvement from a viewpoint of smoothly moving a plurality of moving bodies in an accommodation area.

The present invention provides an accommodation area management device capable of smoothly moving a plurality of moving bodies in an accommodation area.

An embodiment of the present invention is an accommodation area management device which manages an accommodation area for accommodating a moving body, comprising:

a specification unit configured to specify a movement direction or target position of the moving body moving in the accommodation area; and

a processor configured to group a moving body group consisting of a plurality of moving bodies moving in the same movement direction or a plurality of moving bodies moving toward the same target position when there are a plurality of moving bodies moving in the accommodation area, wherein

the processor sets a leading moving body which should be a head from the grouped moving body group and moves the moving group with the set leading moving body at the head while maintaining a constant interval.

According to the embodiment of the present invention, the plurality of moving bodies can be smoothly moved in the accommodation area.

### BRIEF DESCRIPTION OF DRAWINGS

FIG. 1 is a diagram illustrating an example of a configuration of a vehicle system of an embodiment.

FIG. 2 is a diagram illustrating an example of a parking lot managed by a parking lot management device.

FIG. 3 is a diagram illustrating an example of a configuration of the parking lot management device.

FIG. 4 is a diagram illustrating an example of a parking reservation table.

FIG. 5 is a diagram illustrating an example of a parking space status table.

FIG. 6 is a flowchart illustrating a series of processing flows of the parking lot management device.

### DESCRIPTION OF EMBODIMENT

Hereinafter, an embodiment of an accommodation area management device of the invention will be described with reference to the accompanying drawings. In the following embodiment, an example will be described in which a moving body in the invention is a vehicle and an accommodation area in the invention is a parking lot. Further, in the following embodiment, an example in Which the accommodation area management device of the invention is used as a parking lot management device for managing a parking lot will be described.

Vehicle System

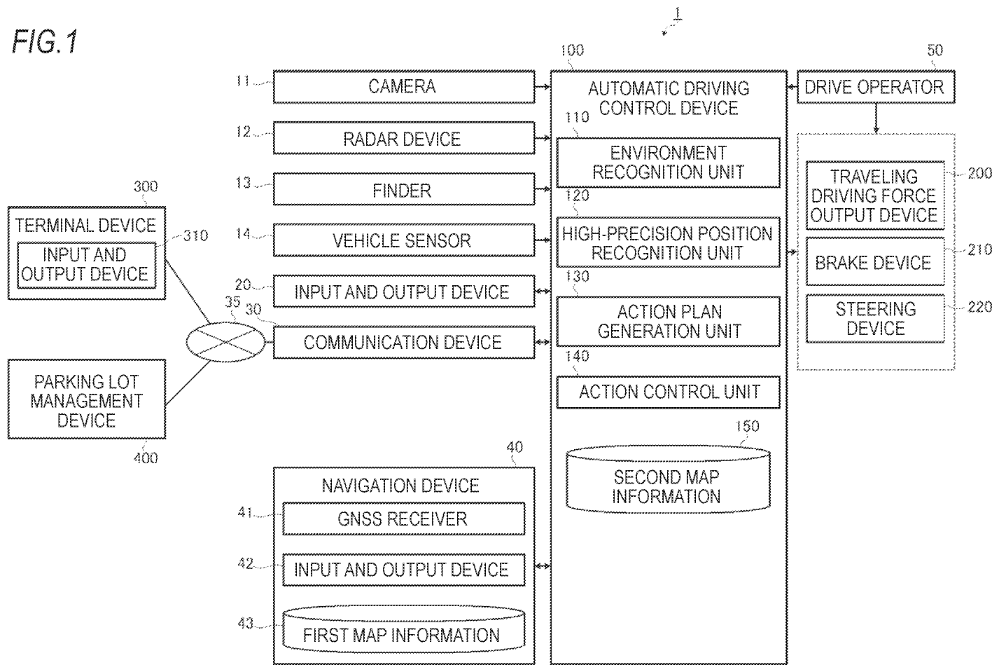

First, a vehicle of the embodiment will be described. In FIG. 1, a vehicle system 1 is mounted on a vehicle having an automatic driving function of a so-called automatic driving level “4” or higher. A vehicle (hereinafter, also referred to as vehicle M) equipped with the vehicle system 1 is a vehicle including a drive source and wheels (for example, two wheels, three wheels, or four wheels) including driving wheels driven by the power of the drive source. The drive source of the vehicle M is, for example, an electric motor. Further, the drive source of the vehicle M may be an internal combustion engine such as a gasoline engine or a combination of an electric motor and an internal combustion engine.

As illustrated in FIG. 1, the vehicle system 1 includes a camera 11, a radar device 12, a finder 13, a vehicle sensor 14, an input and output device 20, a communication device 30, a navigation device 40, a drive operator 50, an automatic driving control device 100, a traveling driving force output device 200, a brake device 210, and a steering device 220. Each of those devices is communicably connected to each other by a wired or wireless communication network. The communication network connecting each of those devices is, for example, Controller Area Network (CAN).

The camera 11 is a digital camera which photographs the periphery (for example, in front of vehicle M) of the vehicle M and outputs image data obtained by the photographing to the automatic driving control device 100. The radar device 12 is, for example, a radar device using radio waves in a millimeter wave band, detects a position of an object in the vicinity (for example, in front of, behind, and to the side of vehicle M) of the vehicle M, and outputs the detection result to the automatic driving control device 100.

The finder 13 is, for example, Laser Imaging Detection and Ranging (LIDAR). The finder 13 uses a predetermined laser beam to measure the distance to an object (target object) around (for example, in front of, behind, and to the side of vehicle M) the vehicle M and outputs the measurement result to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around a vertical axis of the vehicle M, an orientation sensor which detects the orientation of the vehicle M, and the like. Further, the vehicle sensor 14 includes a radio wave intensity sensor which detects the radio wave intensity (that is, the communication intensity) of the radio wave used by the communication device 30, described later, for communication. The vehicle sensor 14 outputs the detection result of each sensor to the automatic driving control device 100 or the like.

The input and output device 20 includes an output device which outputs various kinds of information to a user of the vehicle M and an input device which accepts various input operations from the user of the vehicle M. The output device of the input and output device 20 is, for example, a display which displays based on a processing result of the automatic driving control device 100. The output device may be a speaker, a buzzer, an indicator light, or the like. The input device of the input and output device 20 is, for example, a touch panel or an operation button (key, switch, or the like) which outputs an operation signal corresponding to an input operation received from a user to the automatic driving control device 100.

The communication device 30 is connected to a network 35 and communicates with another device provided outside the vehicle system 1 via the network 35. The network 35 includes, for example, a mobile communication network, a Wi-Fi network, Bluetooth (registered trademark), Dedicated Short Range Communication (DSRC), and the like.

The communication device 30 communicates with, for example, a terminal device 300 carried by a user of the vehicle M, a parking lot management device 400 which manages a parking lot PA where the vehicle M can be parked. The terminal device 300 is, for example, a smartphone or a tablet terminal and is an electronic device connected to the network 35 and including an input and output device 310. The input and output device 310 is, for example, a display which displays various information to a user, a touch panel which accepts a user's input operation, and the like. The parking lot PA and the parking lot management device 400 will be described below.

The navigation device 40 includes a Global Navigation Satellite System (GNSS) receiver 41 and an input and output device 42. Further, the navigation device 40 includes a. storage device (not illustrated) such as a flash memory and first map information 43 is stored in this storage device. The first map information 43 is, for example, information representing a road shape by a link indicating a road and a node connected by the link. Further, the first map information 43 may include information representing the curvature of the road and the Point Of interest (POI).

The GNSS receiver 41 identifies the latitude and longitude of a point where the vehicle M is located as the position of the vehicle M based on the signal received from the GNSS satellite. Further, the navigation device 40 may specify or correct the position of the vehicle M by an Inertial Navigation System (INS) using the output of the vehicle sensor 14.

The input and output device 42 includes an output device which outputs various kinds of information to a user of the vehicle M and an input device which accepts various input operations from a user of the vehicle M. The output device of the input and output device 42 is, for example, a display which displays (for example, displays a route on a map described below) based on the processing result of the navigation device 40. Further, the input device of the input and output device 42 is, for example, a touch panel or an operation button (key, switch, or the like) which outputs an operation signal corresponding to the input operation received from a user to the navigation device 40. The input and output device 42 may be shared with the input and output device 20.

For example, the navigation device 40 determines a route (hereinafter, also referred to as a route on the map) from the position of the vehicle M specified by the GNSS receiver 41 to a destination input by the user with reference to the first map information 43. Then, the navigation device 40 guides the determined route on the map to the user by the input and output device 42. Further, the navigation device 40 outputs information indicating the position of the vehicle M specified by the GNSS receiver 41 and information indicating the determined route on the map to the automatic driving control device 100.

The navigation device 40 may be realized by the function of the terminal device 300. Also, for example, the communication device 30 may transmit information indicating the position of the vehicle M and the destination input by a user to a server device (navigation server) outside the vehicle system 1 and the function of the navigation device 40 may be realized by this server device.

The drive operator 50 is various operators such as an accelerator pedal, a brake pedal, a shift lever, a steering wheel, a deformed steering wheel, and a joystick. The drive operator 50 is provided with a sensor which detects the amount of operation or the presence or absence of operation on the drive operator 50. The detection result by the sensor of the drive operator 50 is output to a part or all of the automatic driving control device 100, the traveling driving force output device 200, the brake device 210, and the steering device 220.

The traveling driving force output device 200 outputs a traveling driving force (torque) for the vehicle M to travel to the driving wheels. The traveling driving force output device 200 includes, for example, an electric motor and an electric motor Electronic Control Unit (ECU) which controls the electric motor. The electric motor ECU controls the electric motor based on the detection result by the sensor of the drive operator 50 (for example, the accelerator pedal) and the control information from the automatic driving control device 100. Further, when the vehicle M includes an internal combustion engine or a transmission as a drive source, the traveling driving force output device 200 may include an internal combustion engine or a transmission and an ECU for controlling the combustion engine or the transmission.

The brake device 210 includes, for example, a brake caliper, a cylinder which transmits hydraulic pressure to the brake caliper, an electric motor which generates hydraulic pressure in the cylinder, and a brake ECU. Based on the detection result by the sensor of the drive operator 50 (for example, the brake pedal) and the control information from the automatic driving control device 100, the brake ECU controls the electric motor of the brake device 210 so that the brake torque corresponding to the braking operation is output to each wheel.

The steering device 220 includes, for example, a steering ECU and an electric motor. The electric motor of the steering device 220, for example, applies a force to the rack and pinion mechanism to change the direction of the steering wheel. Based on the detection result by the sensor of the drive operator 50 (for example, the steering wheel) and the control information from the automatic driving control device 100, the steering ECU drives the electric motor of the steering device 220 to change the direction of the steering wheels.

Automatic Driving Control Device

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like to which each functional unit (for example, high-precision position recognition unit 120) of the automatic driving control device 100 can access and second map information 150 is stored in this storage device.

The second map information 150 is more accurate map information than the first map information 43. The second map information 150 includes, for example, information indicating the center of a lane, information indicating a lane boundary line (for example, a road lane marking), and the like. Further, the second map information 150 may include road information, traffic regulation information, address information, facility information, telephone number information, and the like.

Further, the second map information 150 may be updated at any time by the communication device 30 communicating with another device. For example, when the vehicle M enters the parking lot PA, the communication device 30 receives information (hereafter, also referred to as in-parking-lot map information) indicating the lane in the parking lot PA, the position of each parking space, and the like from the parking lot management device 400. Then, the automatic driving control device 100 updates the second map information 150 so as to incorporate the received in-parking-lot map information into the second map information 150. As a result, the automatic driving control device 100 can specify the position of each parking space in the parking lot PA with reference to the second map information 150.

The environment recognition unit 110 performs sensor fusion processing on information acquired by a part or all of the camera 11, the radar device 12, and the finder 13, in such a manner that the environment recognition unit 110 recognizes an object around the vehicle M and recognizes its position. The environment recognition unit 110 recognizes, for example, an obstacle, a road shape, a traffic light, a guardrail, a utility pole, a surrounding vehicle (including traveling conditions such as speed and acceleration and parking conditions), a lane mark, a pedestrian, and the like and recognizes their positions.

Referring to the position of the vehicle M specified by the navigation device 40, the detection result by the vehicle sensor 14, the image taken by the camera 11, the second map information, and the like, the high-precision position recognition unit 120 recognizes the detailed position and attitude of the vehicle M. The high-precision position recognition unit 120 recognizes, for example, the traveling lane in which the vehicle M is traveling or recognizes the relative position and attitude of the own vehicle with respect to the traveling lane. Further, the high-precision position recognition unit 120 also recognizes, for example, the position of the vehicle M in the parking lot PA.

The action plan generation unit 130 generates an action plan for the vehicle M. Specifically, the action plan generation unit 130 generates a target track on which the vehicle M will travel in the future as an action plan of the vehicle M. The target track is, for example, information in which points (track points) to be reached by the vehicle M are arranged for each predetermined traveling distance (for example, about several [m]). Further, the target track may include information on speed elements such as the target speed and the target acceleration of the vehicle M at each predetermined time or at each track point. The action plan generation unit 130 generates an action plan according to the instructions of the parking lot management device 400 received by the communication device 30, for example.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track and controls the steering device 220 according to a curvature degree of the target track.

Each functional unit included in the automatic driving control device 100 is realized, for example, by the Central Processor (CPU) executing a predetermined program (software). Further, a part or all of the functional units of the automatic driving control device 100 may be realized by hardware such as Large Scale Integration (LSI), Application Specific Integrated Circuit (ASIC), Field-Programmable Gate Array (FPGA), Graphics Processor (GPU), and for example, the storage device for storing the second map information 150 and the high-precision position recognition unit 120 may be realized by a Map Positioning Unit (MPU). Further, a part or all of the functional units of the automatic driving control device 100 may be realized by the cooperation of software and hardware.

Parking Lot Managed by Parking Lot Management Device

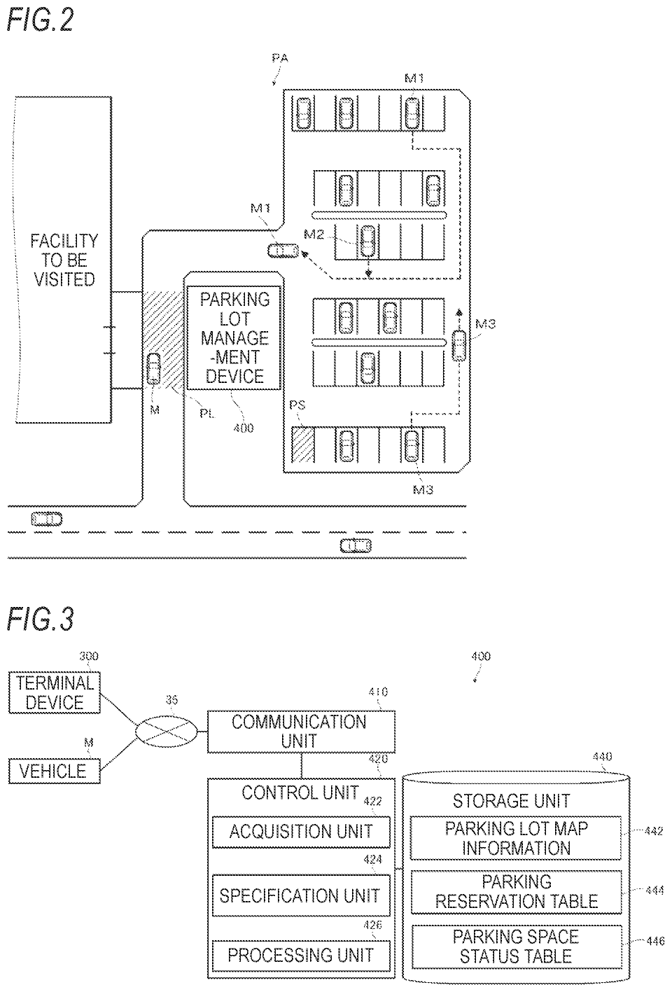

Next, an example of the parking lot PA will be described with reference to FIG. 2. As illustrated in FIG. 2, the parking lot PA is a parking lot managed by the parking lot management device 400 and is an automatic valet parking type parking lot attached to a visited facility to be visited by a user. The parking lot PA includes a plurality of parking spaces PS where a vehicle (for example, vehicle M) can be accommodated and a platform PL provided right before the plurality of parking spaces PS. Hereinafter, an example in which a user of the vehicle M uses the parking lot PA will be described.

Before using the parking lot PA, a user of the vehicle M makes a reservation for using the parking lot PA to the parking lot management device 400 which manages the parking lot PA by using own terminal device 300 or the like. For example, the user inputs own identification information (for example, a user ID described below), the identification information (for example, the vehicle ID described below) of the vehicle M to be parked, a date and time when the parking lot PA is used (for example, a reserved time zone described below), and the like to the terminal device 300 and transmits this information to the parking lot management device 400, in such a manner that the user makes a reservation for using the parking lot PA. Then, when the date and time of the reservation is reached, the user drives the vehicle M to the platform PL and gets off from the vehicle M at the platform PL.

After the user gets off the vehicle M, the vehicle M automatically drives and starts a self-propelled parking event to move to the parking space PS in the parking lot PA. For example, the user sends a request to start a self-propelled entry event to move the vehicle M to the parking space PS to the parking lot management device 400 by using own terminal device 300 or the like, in response to the request to start the self-propelled entry event, the parking lot management device 400 instructs the vehicle M to perform the self-propelled entry event to park in a predetermined parking space PS. According to this instruction, the vehicle M moves to the parking space PS instructed by the parking lot management device 400 while performing guiding by the parking lot management device 400 and sensing with the camera 11, the radar device 12, the finder 13, or the like.

In addition, the vehicle M parked in the parking lot PA can carry out re-parking, so-called “repacking”, in which the parking position is changed to another parking position in the parking lot PA. Reparking is appropriately carried out by a control instruction by the parking lot management device 400 or a voluntary automatic driving by the vehicle M itself.

In addition, at the time of exit from the parking lot PA, the vehicle M is automatically driven and performs a self-propelled exit event to move from the parked parking space PS to the platform PL. For example, the user uses own terminal device 300 or the like to send a request for starting the self-propelled exit event to move the vehicle M to the platform PL to the parking lot management device 400. In response to the request to start the self-propelled exit event, the parking lot management device 400 instructs vehicle M to perform the self-propelled exit event to move the vehicle M from the parked parking space PS to the platform PL. According to this instruction, the vehicle M moves to the platform PL while performing guiding by the parking lot management device 400 and sensing with the camera 11, the radar device 12, the finder 13, or the like. Then, the user gets on the vehicle M which has reached the platform PL and exits from the parking lot PA.

Parking Lot Management Device

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a specification unit 424, and a processor 426. Each component of the control unit 420 is realized, for example, by a hardware processor such as a CPU executing a program (software). Some or all of those components may be realized by hardware (circuit part; including circuitry) such as LSI, ASIC, FPGA, and GPU, or may be realized by collaboration between software and hardware. The program may be stored in advance in a storage device (a storage device including a non-transient storage medium) such as an HDD or a flash memory or, the program may be stored in a removable storage medium (non-transient storage medium) such as a DVD or a CD-ROM and installed by attaching the storage medium to a drive device.

The storage unit 440 stores information such as parking lot map information 442, parking reservation table 444, and a parking space status table 446. The storage unit 440 is realized by an HDD, a flash memory, or the like.

The communication unit 410 wirelessly (for example, network 35) communicates with the vehicle M or the terminal device 300 of the user. The control unit 420 guides the vehicle M to the parking space PS based on the information acquired by the communication unit 410 and the information stored in the storage unit 440. The parking lot map information 442 is information which geometrically represents the structure of the parking lot PA. Further, the parking lot map information 442 includes the coordinates for each parking space PS.

A parking reservation for the vehicle M is input to the acquisition unit 422 from the terminal device 300 of the user of the vehicle M using the communication unit 410. When the parking reservation of the vehicle M is input, the acquisition unit 422 registers the input parking reservation in the parking reservation table 444 of the storage unit 440.

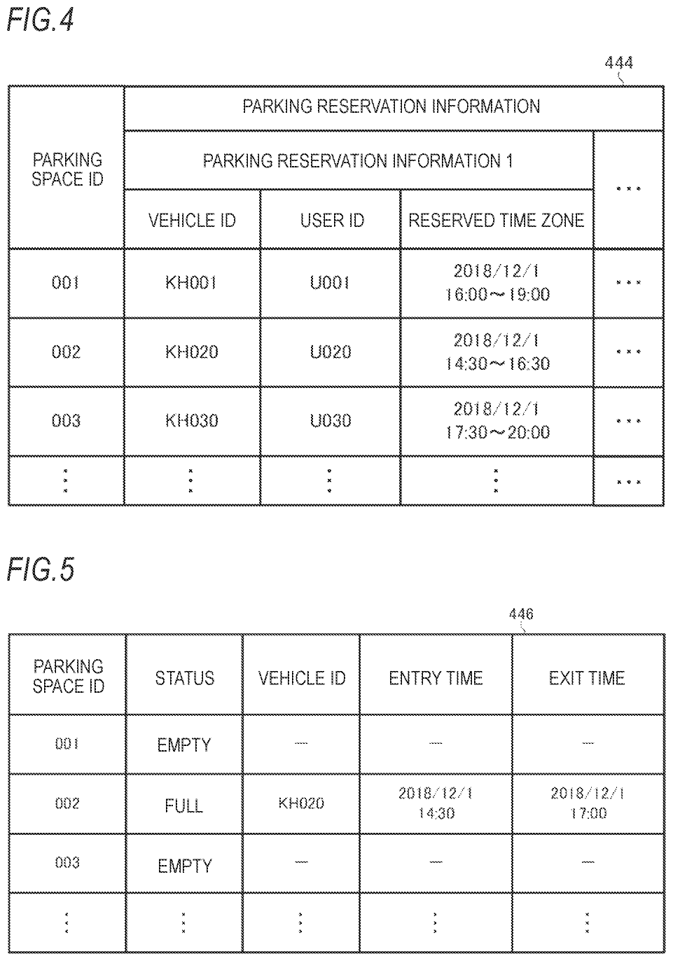

As illustrated in FIG. 4, the parking reservation table 444 stores, for example, parking reservation information in association with a parking space ID, which is identification information of the parking space PS. The parking reservation information includes, for example, information indicating the vehicle ID which is identification information of the vehicle M to be parked and a reserved time zone in which the vehicle M is scheduled to be parked in the parking lot PA. Further, the parking reservation information may include a user ID which is identification information of the user of the vehicle M to be parked.

Further, the acquisition unit 422 can also acquire the position information of the vehicle M already parked in the parking lot PA via the communication unit 410. This position information is stored, for example, in the form of the parking space status table 446. As illustrated in FIG. 5, in the parking space status table 446, the parking space ID, which is the identification information of the space PS, is associated with information indicating whether the parking space PS is empty or full, the Vehicle ID, which is the identification information of the parked vehicle M when the parking space PS is full, and the entry time and exit time (scheduled exit time) of the vehicle M when the parking space PS is full. The entry time and exit time are recorded, for example, in association with the vehicle ID of the vehicle M when the vehicle M enters the parking lot PA. The vehicle ID can be, for example, a vehicle number written on a vehicle number plate (so-called license plate).

In addition, the acquisition unit 422 can also acquire the position information of each vehicle M traveling in the parking lot PA. For example, the vehicle M traveling in the parking lot PA periodically transmits information which associates the vehicle ID of the own vehicle with the position (for example, the position recognized by the high-precision position recognition unit 120) of the own vehicle in the parking lot PA to the parking lot management device 400. The acquisition unit 422 acquires information in which the vehicle ID transmitted from the vehicle M traveling in the parking lot PA and the position in the parking lot PA are associated with each other via the communication unit 410. Further, when the parking lot management device 400 receives the information in which the vehicle ID and the position in the parking lot PA are associated with each other from the vehicle M traveling in the parking lot PA, the parking lot management device 400 may store the received information in a predetermined table of the storage unit 440. Then, the acquisition unit 422 may acquire the position information of the vehicle M traveling in the parking lot PA with reference to this table.

By the way, in the parking lot PA, not only one vehicle but also a plurality of vehicles M are generally traveling. In such a situation, when a vehicle group consisting of a plurality of vehicles M moving in the same driving direction or a plurality of vehicles M moving toward the same target position can be grouped and moved in a convoy in the grouped vehicle group, it is considered that the smooth movement of the grouped vehicle group can be ensured. Here, the target position can be a destination which is the final movement destination, such as the platform PL in the case of exit, the parking space PS in the case of reparking, or the like. Further, the target position may be a waypoint which goes through to reach the destination, for example, a position on a passage in the parking lot PA. That is, the target position is not limited to the destination, and may be a stop position at which the vehicle M is temporarily stopped until the vehicle M reaches the final destination such as the platform PL.

Therefore, the parking lot management device 400 of the embodiment specifies a plurality of vehicles M moving in the same traveling direction or a plurality of vehicles M moving toward the same target position in the parking lot PA and groups a group of vehicles including the plurality of specified vehicles M. Then, the parking lot management device 400 sets a leading vehicle from the grouped vehicle group and makes the grouped vehicle group travel in a convoy with the leading vehicle at the head. Here, traveling in a convoy means, for example, traveling in a row while maintaining a certain interval. As a result, in the parking lot PA, the plurality of vehicles M moving in the same traveling direction or the plurality of vehicles M moving toward the same target position will travel in a convoy, and thus even when many vehicles M travel in the parking lot PA, they can travel smoothly.

In carrying out this, the specification unit 424 specifies a traveling direction or a target position of each vehicle M traveling in the parking lot PA. For example, the specification unit 424 can specify the traveling direction and the parking position (parking space PS where vehicle M is parked) as the target position by referring to the current position of the vehicle M and the parking reservation table 444 for the vehicle M which has entered. Further, the specification unit 424 may specify the traveling direction and the target position of the vehicle M based on a traveling route determined by the processor 426 described below, the current position of the vehicle M and the like.

When there are a plurality of vehicles M traveling in the parking lot PA, based on the traveling direction or target position of each vehicle M specified by the specification unit 424, the processor 426 specifies a plurality of vehicles M moving in the same traveling direction or a plurality of vehicles M moving toward the same target position and groups a group of vehicles including the plurality of specified vehicles M. For example, the processor 426 groups the plurality of vehicles M by setting information in which the specified plurality of vehicles M are associated with each other as the same group.

FIG. 2 illustrates an example in which a plurality of vehicles M1, M2, and M3 travel in the same traveling direction. In the example of FIG. 2, the vehicles M1, M2, and M3 are all moving for exit and traveling in the same traveling direction. Specifically, the vehicles M1, M2, and M3 are all traveling toward the platform PL. In this case, the processor 426 groups the vehicles M1, M2, and M3 traveling in the same traveling direction. The processor 426 can make a group as long as there is not one vehicle M traveling in the same traveling direction.

Further, here, an example in which the vehicles M1, M2, and M3 are grouped because the plurality of vehicles M1, M2, and M3 are traveling in the same traveling direction is described, but the invention is not limited to this. As described above, the vehicles M2, and M3 are all traveling toward the platform PL. That is, the vehicles M1, M2, and M3 are all moving with the target position as the platform PL. Therefore, the processor 426 may group the vehicles M1, M2, and M3 which move toward the same target position. Even in this case, the processor 426 can make a group as long as there is not one vehicle M moving toward the same target position.

Further, the processor 426 sets, for example, a leading vehicle which should be the head of the grouped vehicle group and makes the vehicle group travel in a convoy with the leading vehicle at the head. For example, in the example of FIG. 2, the vehicles M1, M2, and M3 are traveling in a convoy in which the vehicle M1 is the leading vehicle and the vehicle M2 and the vehicle M3 are subsequent vehicles of the vehicle M1. Therefore, the plurality of vehicles M moving in the same traveling direction or the plurality of vehicles M moving toward the same target position can travel in a convoy with the set leading vehicle at the head. As a result, even when many vehicles M travel in the parking lot PA, the smooth movement (traveling) of the vehicles M can be ensured.

Further, in the processor 426, it is desirable to set a high-performance vehicle having the highest performance among the grouped vehicles as the leading vehicle. The “high-performance vehicle having the highest performance” is, for example, a vehicle having the highest (that is, the fastest) set traveling speed, a vehicle having the highest external recognition ability, or the like. Here, the external recognition ability is, for example, the sensing performance by the camera 11, the radar device 12, the finder 13, the vehicle sensor 14, and the like. Further, the set traveling speed is, for example, an upper limit of the traveling speed at the time of automatic driving and is a speed set in advance for each vehicle M based on the external recognition ability of the vehicle M and the like. By doing so, the processor 426 can appropriately form a convoy which can ensure smooth movement.

Further, in the processor 426, for example, among the grouped vehicles, the vehicle M having the highest set traveling speed when traveling in the parking lot PA is set as the leading vehicle, and then the processor 426 may move the grouped vehicles in the order of the set traveling speed. That is, for example, when there is a vehicle M having a low set traveling speed near the beginning of the convoy, the processor 426 takes measures to replace the traveling order (for example, the positions of vehicles M in the convoy) of the vehicles M and forms a convoy in descending order of the set traveling speed. As a result, the vehicle M having a high set traveling speed can be preferentially traveled and quickly guided to a predetermined target position, and as a result, all or a part of the vehicle M belonging to the convoy can be smoothly moved.

It is desirable that the number of vehicles which can be included in the grouped vehicle group is not more than a predetermined upper limit number. As a result, it is possible to prevent the convoy from extending too much. Further, this upper limit number may be variable depending on the performance (for example, the external recognition ability) of the leading vehicle. That is, the upper limit number may be larger for the vehicle group in which the high-performance vehicle is the leading vehicle. As a result, it is possible to form a convoy with an appropriate number of vehicles according to the performance of the leading vehicle, Not limited to this, the upper limit number may be variable depending on the target position (for example, the destination) and the traveling environment (for example, the distance to the target position) of the grouped vehicle group. For example, the upper limit number of grouped vehicles to be exit may be larger than the upper limit number of grouped vehicles to be reparked. In this way, it is possible to form a convoy with an appropriate number of vehicles according to the target position and the traveling environment.

Further, it is desirable that the processor 426 performs grouping when the traveling routes generated for the respective plurality of vehicles M traveling in the parking lot PA overlap. The situation where the traveling routes of the plurality of vehicles M overlap may hinder the smooth movement of those plurality of vehicles M. Therefore, the processor 426 can ensure smooth movement of the vehicles M by grouping the vehicles M having overlapping traveling routes and controlling the vehicles M collectively.

Further, the processor 426 may cause a succeeding vehicle of the grouped vehicles to travel on the traveling route of the leading vehicle. For example, the processor 426 can make the succeeding vehicle travel on the traveling route of the leading vehicle by setting the traveling route of the leading vehicle to the traveling route of the succeeding vehicle as the target route. As a result, even in a situation where the leading vehicle and the succeeding vehicle are separated to some extent, the succeeding vehicle can travel on the same traveling route as the leading vehicle. Also, for example, the processor 426 causes the succeeding vehicle to follow the leading vehicle and causes the succeeding vehicle to travel so as to trace the traveling route of the leading vehicle, in such a manner that the processor 426 may cause the succeeding vehicle to travel on the traveling path of the leading vehicle. For example, in this case, in the example of FIG. 2, the vehicle M2 follows the leading vehicle, the vehicle M1, and the vehicle M3 travels so as to follow the vehicle M2 traveling in front of (immediately before) the vehicle M3. As a result, the plurality of vehicles M can be traveled in a convoy by a simple process.

Further, the processor 426 may set a temporary gathering place of the vehicle group when grouping the vehicles and may gather all the vehicles M of the vehicle group at the gathering place. The temporary gathering place may be the current position of a vehicle M, which is the leading vehicle, a place (for example, a position where the distances from all vehicles M in the vehicle group are approximately equal) where all vehicles M in the vehicle group can easily gather, or a predetermined position which does not interfere with the movement of other vehicles M in the parking lot PA. The gathering place can be appropriately determined by an administrator of the parking lot management device 400 or the like. By gathering all the vehicles M of the vehicle group at the gathering place in this way, it is possible to move those vehicles M after the vehicles M can form an appropriate convoy.

Also, when a waiting time of the leading vehicle exceeds a predetermined time at the gathering place described above, the processor 426 may group a group of vehicles including a plurality of vehicles M gathered at the gathering place including the leading vehicle, and then at least the leading vehicle may be started. As a result, when the arrival of any vehicle M included in the vehicle group at the gathering place is delayed, it is possible to prevent a large number of vehicles M from staying at the gathering place and congesting the parking lot PA. In addition, this makes it possible to suppress a user of the leading vehicle from waiting for a long time in the case of exit, and thus it is possible to improve the convenience of the user.

Further, the processor 426 may allow any vehicle M in the vehicle group to leave in the middle. As a result, it is possible to set a unique target position for each vehicle M included in the vehicle group according to the situation, and thus it is possible to move each vehicle M appropriately. In addition, in the processor 426, when a plurality of vehicles M leave in the middle and the routes of the plurality of vehicles M to leave overlap with each other, those leaving vehicles M may be grouped as a separate group. As a result, the convoy can be reorganized according to the situation. Further, the processor 426 may set a leading vehicle of this other group in the order of leaving the group before leaving. For example, the processor 426 may determine and set the vehicle M, the earliest to leave the group before leaving, as the loading vehicle of the other group. In this way, it is possible to form a convoy more smoothly with the leaving vehicles, and thus the leaving vehicle group can be moved smoothly.

The processor 426 moves the vehicle M to the target position by, for example, setting a target position of the vehicle M and instructing the vehicle M to move to the target position. In this case, the processor 426 may also determine a suitable route to the target position and instruct the vehicle M to move by this route. In addition, the processor 426 may determine a new parking position (new target position) while referring to the parking space status table 446 when it becomes necessary to repark the vehicle M parked in the parking lot PA. In this case, the processor 426 may also determine a suitable route to the new parking position. The target position and route determined by the processor 426 are transmitted to the vehicle M using the communication unit 410.

In the vehicle M which has received the target position and route, the action plan generation unit 130 generates an action plan (for example, a target track), and then the vehicle M is controlled by the action control unit 140 so that the vehicle M acts according to the action plan generated by the action plan generation unit 130. As a result, the vehicle M moves to the target position.

Processing Flow

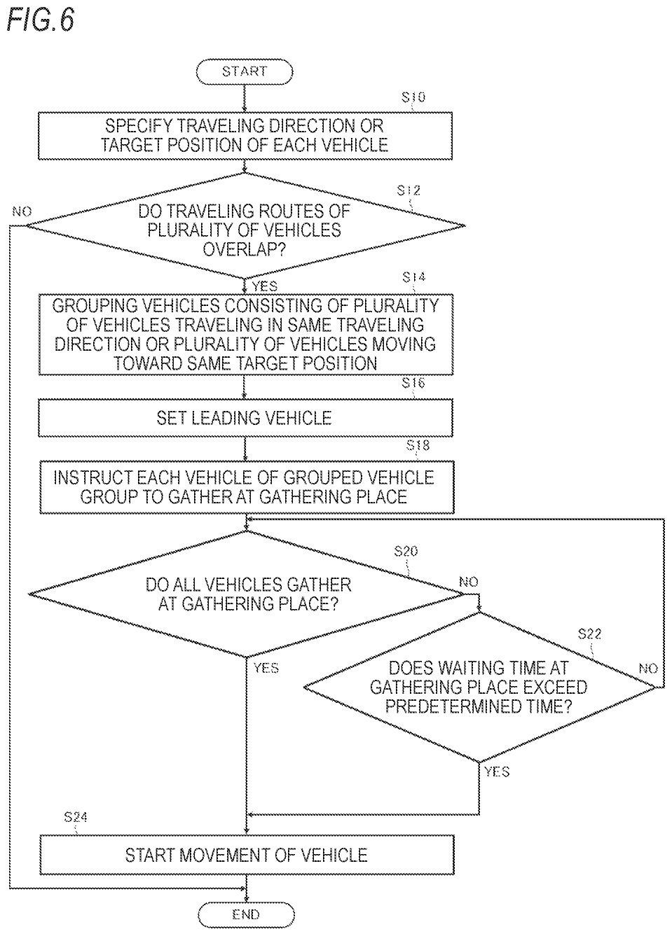

Hereinafter, a series of processing flows of the parking lot management device 400 will be described with reference to FIG. 6. The process illustrated in FIG. 6 may be repeated at a predetermined cycle.

First, the parking lot management device 400 specifies the traveling direction or the target position of each vehicle M traveling in the parking lot PA based on, for example, the position information of each vehicle M traveling in the parking lot PA obtained through the communication unit 410 (Step S10).

Next, the parking lot management device 400 determines whether the travel routes of the plurality of vehicles M generated based on those positions, target positions, and the likes overlap with each other (Step S12). When the traveling routes of the plurality of vehicles M do not overlap (NO in Step S12), the parking lot management device 400 ends the process illustrated in FIG. 6.

When the traveling routes of the plurality of vehicles M overlap with each other (YES in Step S12), the parking lot management device 400 performs grouping of vehicles of these plurality of vehicles M having overlapping traveling paths, that is, the plurality of vehicles M traveling in the same traveling direction or the plurality of vehicles M moving toward the same target position (Step S14). As described above, it is desirable that the parking lot management device 400 keeps the number of vehicles (that is, the vehicles forming a convoy) which can be included in the vehicle group to a predetermined upper limit number or less.

Then, the parking lot management device 400 sets the high-performance vehicle having the highest performance among the grouped vehicles as the leading vehicle at the head of the convoy (Step S16). Next, the parking lot management device 400 instructs each vehicle M of the grouped vehicles to gather at the set gathering place (Step S18).

Then, the parking lot management device 400 determines whether all the vehicles M of the grouped vehicle group have gathered at the gathering place (Step S20). When all the vehicles M of the grouped vehicle group are not gathered at the gathering place (NO in Step 520), the parking lot management device 400 determines whether the waiting time at the gathering place of the vehicle M set as the leading vehicle by the process of Step S16 exceeds a predetermined time (Step S22). When the waiting time at the gathering place does not exceed the predetermined time (NO in Step S22), the process proceeds to Step S20.

When all the vehicles M of the grouped vehicle group have gathered at the gathering place (YES in step S20), or when the waiting time at the gathering place of the leading vehicle exceeds the predetermined time (YES in Step S22), the parking lot management device 400 performs grouping of the vehicles M gathered at the gathering place, forms a convoy with the vehicle M set as the leading vehicle by the process of Step S16 at the head, and starts the movement of the vehicles M (Step S24), and then the process illustrates in FIG. 6 ends. Further, the parking lot management device 400 may start only the leading vehicle by the process of Step S24 when the waiting time at the gathering place of the leading vehicle exceeds the predetermined time.

Further, the parking lot management device 400 may set the leading vehicle by performing the process of Step S16 after gathering the grouped vehicles at the gathering place,

In this case, the parking lot management device 400 may determine, for example, in the process of Step S22 whether the waiting time at the gathering place of the vehicle M which first arrives at the gathering place exceeds the predetermined time.

Further, the parking lot management device 400 may allow the vehicle M of the vehicle group to leave in the middle at an arbitrary time after Step S24, for example. Then, when a plurality of vehicles M leave in the middle and the routes of the plurality of leaving vehicles M overlap each other, the parking lot management device 400 may group the leaving vehicles M as another group. Further, the parking lot management device 400 may determine the leading vehicle of this other group based on the order of leaving from the group before leaving.

The embodiment described above is an example in which the moving body is a vehicle and the accommodation area is a parking lot. However, the idea of the invention is not limited to such an embodiment and is also applied to a moving body (for example, a robot) other than a vehicle. That is, under the concept of the invention, “parking” is extended to the concept of “stop” and “traveling” is extended to the concept of “movement”, and further the “parking lot management device” of the embodiment is extended to the concept of “accommodation area management device”. The repark also includes an operation of “restopping to change the accommodation position of the stopped moving body to another accommodation position in the accommodation area” or “the stopped moving body moves to another accommodation position in the accommodation area and stops again”.

The embodiment for carrying out the invention is described above using the embodiment. However, the invention is not limited to the embodiments and various modifications and substitutions can be made without departing from the gist of the invention.

In addition, at least the following matters are described in this specification. The components and the like corresponding to those in the embodiment described above are shown in parentheses, but the invention is not limited thereto.

(1) An accommodation area management device (parking lot management device 400) which manages an accommodation area (parking lot PA) for accommodating a moving body (vehicle M), including:

a specification unit (specification unit 424) which specifies a movement direction or target position of the moving body moving in the accommodation area; and

a processor (processor 426) which groups a moving body group consisting of a plurality of moving bodies moving in the same movement direction or a plurality of moving bodies moving toward the same target position when there are a plurality of moving bodies moving in the accommodation area, where

the processor sets a leading moving body which should be a head from the grouped moving body group and moves the moving group with the set leading moving body at the head while maintaining a constant interval.

According to (1), smooth movement of the plurality of moving bodies moving in the same moving direction the plurality of moving bodies moving toward the same target position can be ensured.

(2) The accommodation area management device according to where

the processor sets a high-performance moving body having the highest performance among the moving body group as the leading moving body.

According to (2), it is possible to appropriately form a convoy which can ensure smooth movement.

(3) The accommodation area management device according to (2), where

the performance includes a set traveling speed set in advance for each moving body, and

the processor sets the high-performance moving body haying the highest set traveling speed when moving in the accommodation area among the moving body group as the leading moving body and causes the moving body group to continuously move in descending order of the set traveling speed when moving in the accommodation area with the set leading moving body at the head.

According to (3), it is possible to appropriately form a convoy which can ensure smooth movement.

(4) The accommodation area management device according to any one of (1) to (3), where

the number of moving bodies which can be included in the moving body group is equal to or less than a predetermined upper limit number

According to (4), it is possible to prevent the convoy from extending too much.

(5) The accommodation area management device according to (4), where the upper limit number is a value according to the performance of the leading moving body.

According to (5), it is possible to form a convoy with an appropriate number of vehicles according to the performance of the leading vehicle,

(6) The accommodation area management device according to (4), where

the upper limit number is a value according to the target position or traveling environment of the moving body group.

According to (6), a convoy can be formed with an appropriate number of moving bodies according to the target position or traveling environment of the moving body group.

(7) The accommodation area management device according to any one of (1) to (6), where

the processor groups a plurality of moving bodies when traveling paths generated for the plurality of moving bodies moving in the accommodation area overlap.

According to (7), even when the plurality of moving bodies move in the accommodation area, smooth movement of those plurality of moving bodies can be ensured.

(8) The accommodation area management device according to any one of (1) to (7), where

the processor causes a succeeding moving body of the moving body group to move on a traveling path of the leading moving body.

According to (8), the convoy can be moved appropriately.

(9) The accommodation area management device according to any one of (1) to (8), where

the processor sets a temporary gathering place of the moving body group and gathers all the moving bodies of the moving body group at the gathering place when grouping the moving body group.

According to (9), the moving body group can be moved after the convoy is properly formed.

(10) The accommodation area management device according to (9), where

the processor groups a moving body group consisting of a plurality of moving bodies gathered at the gathering place including the leading moving body and at least starts the leading moving body when a waiting time of the leading moving body exceeds a predetermined time at the gathering place.

According to (10), it is possible to suppress congestion of the accommodation area.

(11) The accommodation area management device according to any one of (1) to (10), where

the processor allows any of the moving body in the moving body group to leave in the middle.

According to (11), it is possible to appropriately move each moving body of the moving body group according to the situation.

(12) The accommodation area management device according to (11), where

the processor groups a moving body group consisting of a plurality of leaving moving bodies when the plurality of moving bodies leave from the moving body group in the middle and routes of the plurality of leaving moving bodies overlap.

According to (12), it is possible to appropriately move each moving body of the moving body group according to the situation.

(13) The accommodation area management device according to (12), where

the processor sets a leading moving body of the moving body group consisting of the plurality of leaving moving bodies based on order of leaving.

According to (13), it is possible to form the convoy smoothly by the moving body group consisting of the plurality of leaving moving bodies and this moving body group can be smoothly moved.

What is claimed is:

1. An accommodation area management device which manages an accommodation area for accommodating a moving body, comprising:
a specification unit configured to specify a movement direction or target position of the moving body moving in the accommodation area; and
a processor configured to group a moving body group consisting of a plurality of moving bodies moving in the same movement direction or a plurality of moving bodies moving toward the same target position when there are a plurality of moving bodies moving in the accommodation area, wherein
the processor sets a leading moving body which should be a head from the grouped moving body group and moves the moving group with the set leading moving body at the head while maintaining a constant interval.

2. The accommodation area management device according to claim 1, wherein
the processor sets a high-performance moving body having the highest performance among the moving body group as the leading moving body.

3. The accommodation area management device according to claim 2, wherein
the performance includes a set traveling speed set in advance for each moving body, and
the processor sets the high-performance moving body having the highest set traveling speed when moving in the accommodation area among the moving body group as the leading moving body and causes the moving body group to continuously move in descending order of the set traveling speed when moving in the accommodation area with the set leading moving body at the head.

4. The accommodation area management device according to claim 1, wherein
the number of moving bodies which can be included in the moving body group is equal to or less than a predetermined upper limit number.

5. The accommodation area management device according to claim 4, wherein
the upper limit number is a value according to the performance of the leading moving body.

6. The accommodation area management device according to claim 4, wherein
the upper limit number is a value according to the target position or traveling environment of the moving body group.

7. The accommodation area management device according to claim 1, wherein
the processor groups a plurality of moving bodies when traveling paths generated for the plurality of moving bodies moving in the accommodation area overlap.

8. The accommodation area management device according to claim 1, wherein
the processor causes a succeeding moving body of the moving body group to move on a traveling path of the leading moving body.

9. The accommodation area management device according to claim 1, wherein
the processor sets a temporary gathering place of the moving body group and gathers all the moving bodies of the moving body group at the gathering place when grouping the moving body group.

10. The accommodation area management device according to claim 9, wherein
the processor groups a moving body group consisting of a plurality of moving bodies gathered at the gathering place including the leading moving body and at least starts the leading moving body when a waiting time of the leading moving body exceeds a predetermined time at the gathering place.

11. The accommodation area management device according to claim 1, wherein
the processor allows any of the moving body in the moving body group to leave in the middle.

12. The accommodation area management device according to claim 11, wherein
the processor groups a moving body group consisting of a plurality of leaving moving bodies when the plurality of moving bodies leave from the moving body group in the middle and routes of the plurality of leaving moving bodies overlap.

13. The accommodation area management device according to claim 12, wherein
the processor sets a leading moving body of the moving body group consisting of the plurality of leaving moving bodies based on order of leaving.
